(19) United States
(12) Patent Application Publication
(10) Pub. No.: US 2011/0108579 A1
(43) Pub. Date: May 12, 2011

(54) PUMP RETENTION COLLAR AND METHODS FOR USING THE SAME

(75) Inventors: Haydee Martorell Pena, St. Andrew de Llavaneres (ES); Sergi Llambrich Arrtigas, Vilanova i la Geltru (ES)

(73) Assignee: Meadwestvaco Corporation

(21) Appl. No.: 12/993,365

(22) PCT Filed: May 19, 2009
(86) PCT No.: PCT/US09/44509

§ 371 Date: Jan. 25, 2011

Related U.S. Application Data
(60) Provisional application No. 61/054,208, filed on May 19, 2008.

(51) Int. Cl. B65D 88/54; G01F 11/00

(52) U.S. Cl. 222/321.1; 222/321.9

(57) ABSTRACT

A pump retention collar for assembling a pump on a bottle may be made of a plastic or resin material and may be configured to fit any number of pump sizes, bottle sizes, or bottle neck finishes such that one collar may be used interchangeably with numerous production configurations.

### CROSS-REFERENCE TO RELATED APPLICATIONS

This application claims the benefit of U.S. Provisional Application No. 61/054,208, entitled “PUMP RETENTION COLLAR AND METHODS FOR USING THE SAME,” filed 19 May 2008, and incorporates the same herein by reference in its entirety.

### BACKGROUND OF THE INVENTION

1. Field of the Invention

Various embodiments of the invention relate to retention collars and more particularly to plastic retention collars for attaching or securing pumps to bottles or containers.

2. State of the Art

Pumps and pumping devices are commonly attached to bottles or containers using a retention collar. Typically, the retention collar helps hold a pump to a neck or to an annular rim of the neck of a bottle.

In some instances, a metal crimping procedure may be used to hold a pump onto a bottle. For instance, bottle stoppers are known which operate by means of a ferrule of metallic material. They are used for stopping all kinds of bottles or flasks which have a neck with an outer annular rim on the upper edge of the neck. The outer annular rim usually has the upper portion thereof flat and flush with the upper edge of the bottle and the lower portion thereof is joined to the outer side surface of the neck at an intermediate point thereof. The ferrule is a metal part which is usually provided with a flat annular portion, and a cylindrical portion attached to the flat annular portion at the outer end thereof and perpendicular to said flat annular portion. When the ferrule is mounted on the bottle or flask, the flat annular portion bears against the outer annular rim, or on a resilient ring, the purpose of which is to improve the tightness of the closure and which is placed, in this case, on the outer annular rim. The flat annular portion is, in any case, generally parallel to the upper end of the outer annular rim. The cylindrical portion, then, externally surrounds the outer annular rim. Thereafter, it is necessary to carry out an operation which tightens the cylindrical portion against the outer annular rim, deforming it and thereby attaching the ferrule to the bottle.

In other cases, pumps may be attached to bottles using a frictional fit similar to the methods and apparatus disclosed in U.S. Pat. No. 6,772,893, which is incorporated herein by reference in its entirety, and which discloses a metallic cap used as a retention collar. A metallic cap fits over a main body having tabs and presses the main body against the bottle and secures the tabs under an annular rim of the bottle. The metallic cap and main body secure a pump in an opening of the bottle. Various metallic cap and main body attachment systems are known and frequently used to attach pumps to bottles, especially for fragrance systems and pumps.

While the use of a metallic cap and main body system is advantageous and, in some cases, more aesthetically pleasing than ferrule systems, the use of a metallic cap and main body typically requires multiple configurations to fit on all of the different bottle sizes. For example, bottles having different neck heights require different metallic cap sizes to adequately fit the bottle. In addition, different pump sizes may require different height or sized metallic caps to cover the pump when attached to the bottle. In order to provide the properly sized metallic cap for a pump system, many different sizes may need to be made or stored to be used with the appropriate assembly line. In addition, when assembling pumps or metallic cap and main body systems, the change-over from one size of a metallic cap to another size to accommodate a new pump size consumes time and resources. Furthermore, the availability of metallic caps and their costs may vary.

Therefore, it may be desirable to produce or use a cap or collar that may be used with multiple sized bottles or pump systems. It may also be beneficial to produce or use a cap of collar that is not made of metal.

### BRIEF SUMMARY OF THE INVENTION

According to various embodiments of the invention, a collar for attaching a pump assembly to a bottle may be made of plastic or other moldable material. The collar may be configured to attach a pump assembly to any one or more of a plurality of bottles or a plurality of bottles having different neck finishes.

In some embodiments of the invention, a collar configured to attach a pump to one or more bottles may include one or more ridges or grooves on an interior surface of the collar. The one or more ridges or grooves may improve retention forces applied by the collar to a bottle or by a combination of a collar and a body member to a bottle.

In other embodiments of the invention, a collar configured to attach a pump to one or more bottles may include one or more teeth on an interior surface of the collar. The one or more teeth may be configured to interact with a body member or a pump being attached to a bottle by the collar.

According to other embodiments of the invention, a collar may include one or more teeth on an interior surface of the collar and configured to mate with one or more ridges or projections of a body member. In other embodiments, the collar may include ridges or projections and the body member may include one or more teeth. In either event, the teeth and ridges or projections may mate together to hold the collar on a body member in a pre-assembly position such that the collar and body member may be partially assembled and shipped as a single unit or introduced to an assembly process as a single unit.

### BRIEF DESCRIPTION OF THE DRAWINGS

While the specification concludes with claims particularly pointing out and distinctly claiming some embodiments which are regarded as the invention, the features of various embodiments of the invention can be more readily ascertained from the following detailed description of the invention when read in conjunction with the accompanying drawings in which:

FIG. 1 illustrates a collar for a pump according to various embodiments of the invention;

FIG. 2 illustrates an assembly of a collar according to embodiments of the invention with a body member and a bottle;

FIG. 3 illustrates a cross sectional view of a collar according to certain embodiments of the invention;

FIG. 4 illustrates a cross sectional view of a pump assembly attached to a bottle having a first neck finish according to embodiments of the invention;

FIG. 5 illustrates a cross sectional view of a pump assembly attached to a bottle having a second neck finish according to embodiments of the invention;

FIG. 6 illustrates a cross sectional view of a pump assembly attached to a bottle according to embodiments of the invention;

FIG. 7 illustrates a collar according to various embodiments of the invention;

FIG. 8 illustrates a cross sectional view of a collar according to various embodiments of the invention;

FIG. 9 illustrates a cross sectional view of a collar according to various embodiments of the invention;

FIG. 10 illustrates a cross sectional view of a pump assembly attached to a bottle having a first neck finish according to embodiments of the invention;

FIG. 11 illustrates a cross sectional view of a pump assembly attached to a bottle having a second neck finish according to embodiments of the invention;

FIG. 12 illustrates a cross sectional view of a pump assembly attached to a bottle according to embodiments of the invention;

FIG. 13 illustrates a collar and a body member of a pump assembly according to embodiments of the invention; and

FIG. 14 illustrates a cross sectional view of a collar and body member assembly according to embodiments of the invention.

### DETAILED DESCRIPTION OF THE INVENTION

According to various embodiments of the invention, a universal collar for attaching a pump to a bottle or a container may be used with different sized bottles or bottle neck finishes. In some embodiments of the invention, the collar may be made of metal, plastic, resin, or other material. According to various embodiments of the invention, a collar may also include bumps, ridges, teeth, or other projections on an interior surface thereof. In other embodiments, an interior surface of a collar may be smooth.

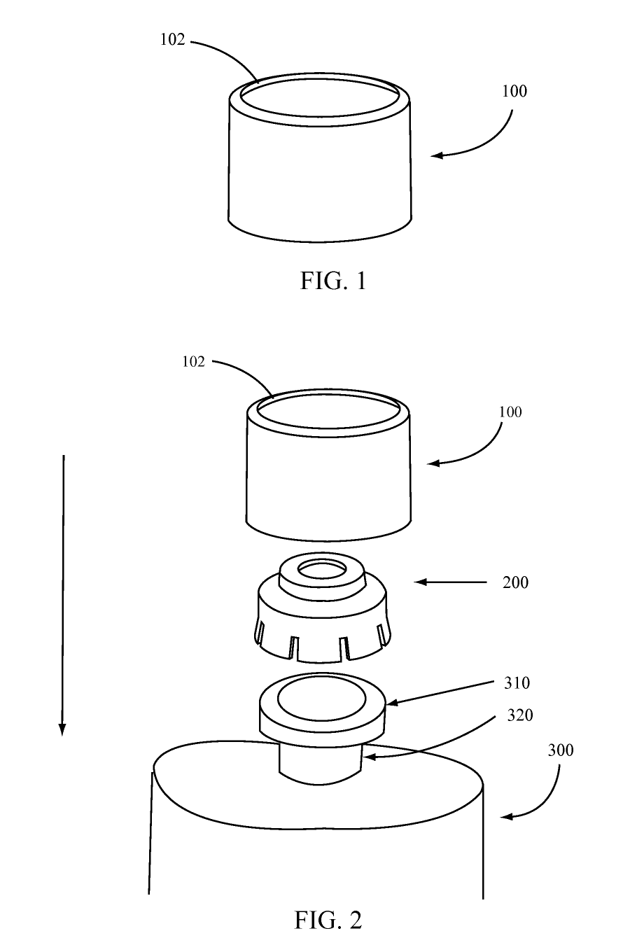

According to certain embodiments of the invention, a collar adapted for holding a pump on a bottle or container may be made of a plastic material. As illustrated in FIG. 1, a collar 100 may be a cylindrically shaped sleeve defining a longitudinal axis and having a sidewall. An upper end of the collar 100 may include a ledge 102 or an annular surface extending inwards from the sidewall towards the longitudinal axis of the collar 100. The ledge 102 may be used to engage a body member (not shown) or pump body (not shown) during an assembly process. An opposite end of the collar 100 may be open such that the open end in combination with the sidewall and the ledge 102 define an interior into which a body member, pump body, or bottle fitting may fit. A collar 100 according to various embodiments of the invention may be made from any suitable plastic material or moldable material.

A collar 100 according to embodiments of the invention may be used to secure a body member 200 to a bottle 300. A pump body (not shown) may be attached to the bottle 300 by the body member 200 as known. As illustrated in FIG. 2, a body member 200, such as those described in U.S. Pat. No. 6,772,893, may be fitted over a bottle 300 such that tabs 210 of the body member 200 fit over a rim 310 of a bottle 300. A collar 100 may be pressed down over the body member 200 on the bottle 300 to secure the body member 200 to the bottle 300. For example, as the collar 100 and body member 200 illustrated in FIG. 2 move in the direction of the arrow onto the bottle 300, the collar 100 will secure the body member 200 to the bottle 300.

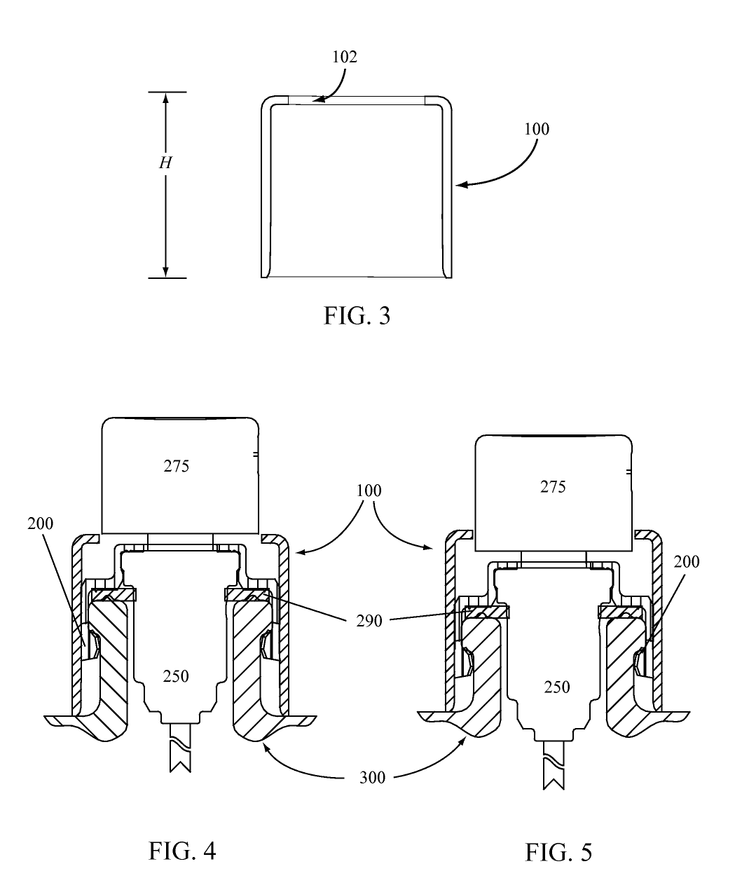

According to various embodiments of the invention, a collar 100 may be sized to fit more than one sized bottle 300, container, or bottle neck finish. A cross sectional view of a collar 100 according to embodiments of the invention is illustrated in FIG. 3. As illustrated, the collar 100 may have a smooth interior surface. The collar 100 may also have a height H as illustrated. The height H of the collar 100 may be selected such that it may fit more than one bottle 300 size or more than one bottle neck finish. For example, the collar 100 may be assembled with a body member 200, a pump 250, a pump head 275, and a bottle 300 having a first bottle neck finish as illustrated in FIG. 4. A gasket 290 may be positioned between the bottle 300 and the body member 200. The same collar 100 may be assembled with a body member 200, a gasket 290, a pump 250, a pump head 275, and a bottle 300 having a second, shorter, bottle neck finish as illustrated in FIG. 5. In each of the assemblies illustrated in FIG. 4 and FIG. 5, the collar 100 secures a pump body 200 and a pump 250 to the bottle 300 and allows a pump head 275 to be activated such that a spray is produced from the pump head 275.

According to embodiments of the invention, the collar 100 height H may be selected such that a collar 100 may be used with multiple bottle neck finishes or bottles 300. The ability or option to use a single collar 100 with a plurality of bottle 300 sizes or bottle neck finishes may simplify an assembly process. For example, in a method of assembling a pump assembly with a bottle 300 having a first bottle neck finish, a pump assembly including a collar 100, a body member 200 partially inserted in the collar 100, a pump 250 positioned in the body member 200, and a pump head 275 attached to the pump 250 may be automatically or manually fitted to the bottle 300 having a first bottle neck finish. The same pump assembly may be automatically or manually fitted to a second bottle 300 having a second bottle neck finish. This may allow an assembly line to run multiple bottle neck finishes on a filling line using the same pump assembly. This may also reduce the number of changes necessary to a filling line due to bottle size changes. The reduced number of changes in the filling line may provide economic benefits.

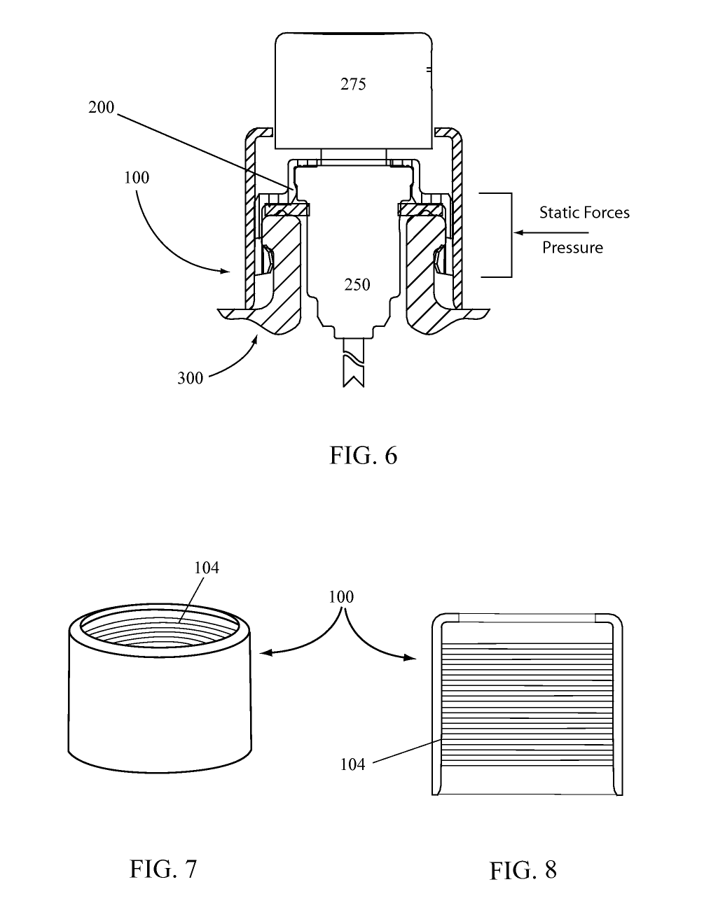

FIG. 6 illustrates a pump assembly according to embodiments of the invention attached to a bottle 300. When the pump assembly is assembled to the bottle 300, the body member 200 fits over an annular portion of the bottle neck, a lip on the bottle neck, or other projection on the bottle neck. Collar 100 is pushed over the body member 200, forcing tabs, projections, or other portions of the body member 200 to grab or otherwise mate with the bottle neck finish. When the collar 100 is in place, forces exerted by the body member 200 on the collar 100 may prevent the collar 100 from being removed from the bottle 300 or make it difficult to disassemble the pump assembly from the bottle 300. As illustrated in FIG. 6, static frictional forces and pressure exerted in the area generally shown in FIG. 6 may assist in retaining the collar 100 and body member 200 on a bottle 300.

A collar 100 according to other embodiments of the invention is illustrated in FIG. 7. As illustrated, a collar 100 may include one or more ridges or grooves 104 on an interior surface of the collar 100. The ridges or grooves 104 may be positioned as desired. In some embodiments, the ridges or grooves 104 may provide or apply additional forces between a body member 200 and the collar 100 to help retain the body member 200 in a locked position over a neck of a bottle 300.

A cross sectional view of a collar 100 having ridges or grooves 104 is illustrated in FIG. 8. Although a definite number of ridges or grooves 104 are illustrated on the interior surface of the collar 100 in FIG. 8, it is understood that the collar 100 may include any number or size of ridges or grooves 104 as desired. In addition, the ridges or grooves 104 need not be linear; they may follow any desired path. In addition, the ridges or grooves 104 may be configured to correspond with ridges or grooves in a body member 200 such that the ridges and grooves 104 of the collar 100 interact with the ridges or grooves of the body member 200. The interaction of ridges or grooves 104 of the collar 100 with ridges or grooves of a body member 200 may assist or improve the retention forces applied to a bottle 300 by a collar 100 or a body member 200 or both.

Ridges or grooves 104 in the collar 100 may also be configured to improve the strength of the collar 100 such that higher retention forces may be achieved with a pump assembly. Ridges or grooves 104 in the collar 100 may also be configured to improve the structural strength of the collar 100. For example, the addition of ridges or grooves 104 on an interior surface of a collar 100 may decrease the thickness required for the collar 100, thereby reducing the amount of material used to make the collar 100.

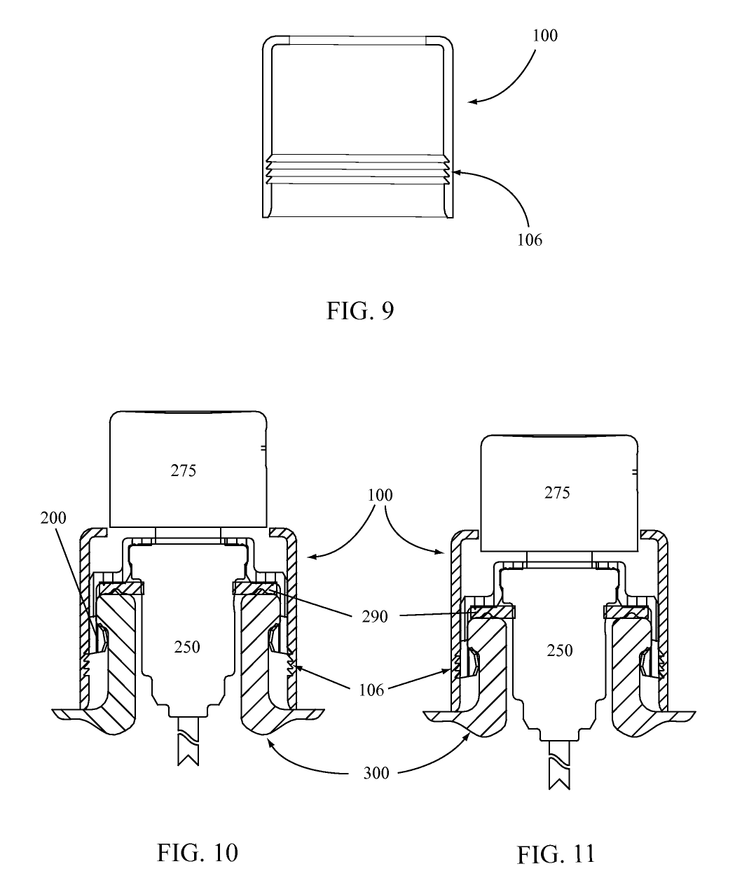

FIG. 9 illustrates a cross sectional view of a collar 100 according to still other embodiments of the invention. As illustrated in FIG. 9, an interior portion of the collar 100 may include one or more teeth 106. Although the teeth 106 illustrated in FIG. 9 circumscribe the entire circumference of an interior surface of the collar 100, it is understood that the teeth 106 do not need to circumscribe the entire circumference of the collar 100. In some embodiments, the teeth 106 may be positioned on only a portion of the interior of the collar 100. In addition, the number of teeth 106 on an interior surface of a collar 100 is not limited. The shape of the teeth 106 is also unlimited. For example, the teeth 106 may be sharp or they may be rounded or dull.

According to various embodiments of the invention, a collar 100 including teeth 106 as illustrated in FIG. 9 may be used with a pump assembly to fix the pump assembly to a bottle 300. When a pump assembly is engaged over a bottle 300 and the collar 100 is pushed down over a body member 200, the teeth 106 of the collar 100 may interact with or engage with a bottom portion of the body member 200 to help retain the collar 100 in a position on the bottle 300. For example, a pump assembly including a collar 100 having teeth 106 according to various embodiments of the invention is illustrated in FIG. 10 attached to a bottle 300 having a first bottle neck finish. As illustrated in FIG. 10, the top tooth in the collar 100 interacts with the bottom portion of the body member 200, providing a groove in the collar 100 in which a portion of the body member 200 may enter. A pump assembly including a collar 100 having teeth 106 according to various embodiments of the invention is also illustrated in FIG. 11 attached to a bottle 300 having a second bottle neck finish which is shorter than the bottle neck finish illustrated in FIG. 10. As illustrated in FIG. 11, a different tooth interacts with the body member 200 due to the different size of the bottle neck finish to which the pump assembly is attached.

According to embodiments of the invention, teeth 106 may be positioned within a collar 100 such that the collar 100 may be used with multiple bottle 300 sizes or neck finishes.

In some embodiments of the invention, the teeth 106 on an interior surface of a collar 100 may interact with tabs of a body member 200 such that when an attempt to pull the collar 100 off of a bottle 300 is made, the teeth 106 may grab the tabs of the body member 200 and pull them away from the bottle 300, which in turn may increase the retention force applied to the bottle 300 by the body member 200.

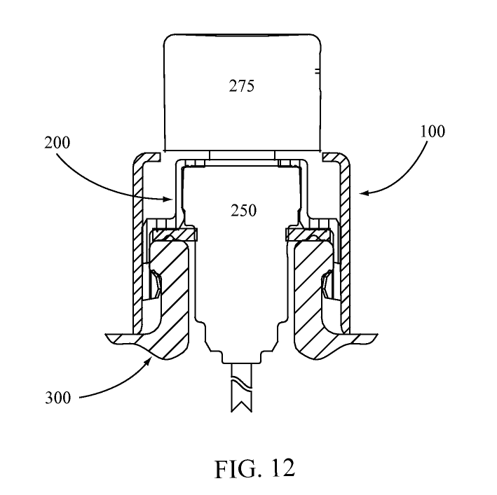

While various embodiments of the invention have been described with respect to different bottle 300 sizes and different bottle neck finishes, embodiments of the invention may also be used to accommodate the attachment of pumps having different sizes to bottles 300. For example, a pump 250 having a body which is longer or larger than the pump illustrated in FIG. 5 is illustrated in FIG. 12. As illustrated, a collar 100 according to embodiments of the invention may be used to attach the body member 200 to the bottle 300. In this instance, a differently sized body member 200 may be needed. In other embodiments, a pump assembly according to embodiments of the invention may be fitted to a bottle 300 to secure a larger pump 250.

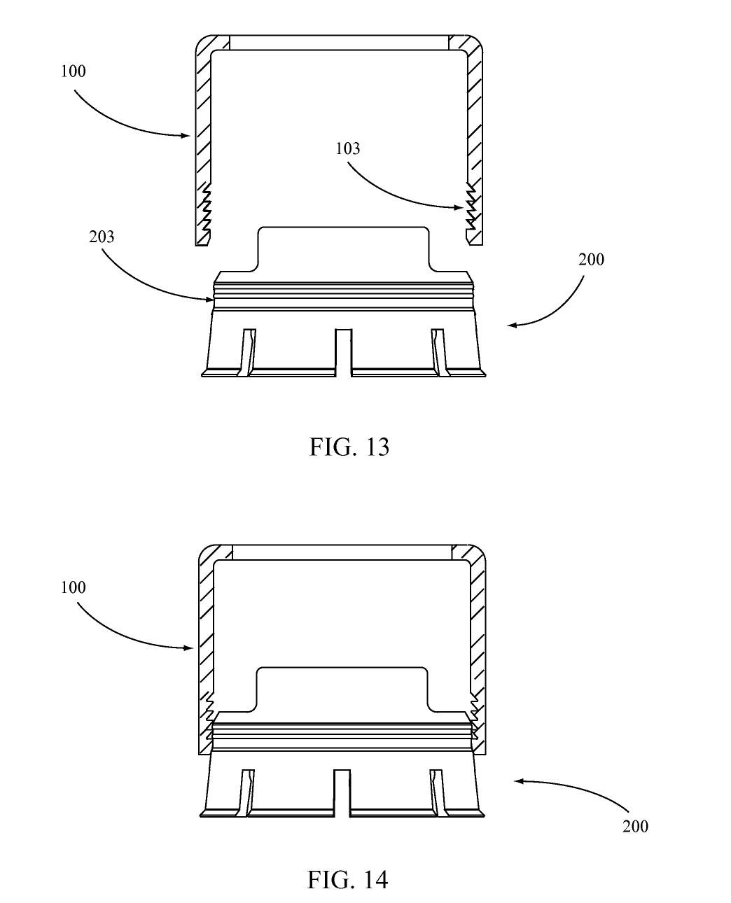

According to other embodiments of the invention, a collar 100 may include one or more teeth 103 which may be used to secure the collar 100 to a body member 200 prior to assembly of the body member 200 and collar 100 to a container or bottle. For example, the collar 100 illustrated in FIG. 13 includes a group of teeth 103 on an interior surface of the collar 100. The teeth 103 may be configured to mate with or attach to one or more ridges 203 or projections on the body member 200. As illustrated in FIG. 14, when the collar 100 having teeth 103 is pushed over the upper portion of the body member 200 at least one of the teeth 103 engages at least one of the ridges 203. Engagement of one or more teeth 103 with one or more ridges 203 may secure the collar 100 to the body member 200 such that the collar 100 and body member 200 may be shipped together or provided to an assembly process as a single unit for assembly with a pump and a container or bottle.

While various embodiments of the invention include descriptions of collars 100 made of a plastic or resin material, the collars 100 according to various embodiments of the invention may be made of any suitable material. In addition, the collars 100 and other parts of the pump, such as the pump head 275, may be decorated using a sublimation process such that a desired pattern or decoration may be added to the pump. For example, a collar 100 and pump head 275 made of a plastic or resin material may be decorated using a sublimation process such that the decorations applied to the collar 100 and pump head 275 are fixed in the plastic or resin material of the collar 100 and pump head 275. In this manner, various decorations may be added to collars 100 and pump heads 275 according to embodiments of the invention.

Having thus described certain particular embodiments of the invention, the invention is not limited to these described embodiments. Rather, the invention is limited only by the appended claims, which include within their scope all equivalent devices or methods which operate according to the principles of the invention as described.

Having thus described certain particular embodiments of the invention, it is understood that the invention defined by the appended claims is not to be limited by particular details set forth in the above description, as many apparent variations thereof are contemplated. Rather, the invention is limited only be the appended claims, which include within their scope all equivalent devices or methods which operate according to the principles of the invention as described.

1-14. (canceled)

15. A pump assembly, comprising:
a collar;
at least one tooth on an interior surface of the collar;
a body member;
at least one ridge on the body member wherein at least one tooth engages with the at least one ridge; and
a pump.

16. The pump assembly of claim 15, further comprising a pump head attached to the pump.

17. The pump assembly of claim 15, wherein a plurality of the at least one tooth engage with a plurality of the at least one ridge.

18. The pump assembly of claim 15, wherein the collar comprises plastic.

19. The pump assembly of claim 15, wherein the collar comprises metal.

20. The pump assembly of claim 15, further comprising at least one tab on a bottom portion of the body member configured to engage at least one tooth in an assembled configuration.

21. The pump assembly of claim 15, further comprising at least one ridge (104) on an interior surface of the collar.

22. The pump assembly of claim 21, wherein the at least one ridge on an interior surface of the collar engages with the at least one ridge on the body member to retain the collar on the body member as a single unit.

23. A method for attaching a pump to a bottle, comprising:
providing a bottle;
providing a pump assembly, comprising:
a pump;
a body member; and
a collar, wherein the body member and collar are attached together;
inserting at least a portion of the pump in an opening in the bottle;
fitting the body member over a rim of the bottle; and
pressing the collar over the body member to secure the body member to the bottle.

24. The method of claim 23, further comprising inserting a gasket between the body member and the bottle.

25. The method of claim 23, wherein providing a pump assembly further comprises:
providing a body member with at least one ridge and an opening in the body member;
inserting at least a portion of a pump through the opening in the body member; and
fixing a collar having at least one tooth to the at least one ridge of the body member.

26. The method of claim 25, further comprising attaching a pump head to the pump.

27. The method of claim 25, wherein fixing a collar having at least one tooth to the at least one ridge of the body member comprises fixing a plurality of teeth on the collar to a plurality of ridges on the body member.
